(19) United States
(12) Patent Application Publication
(10) Pub. No.: US 2012/0036977 A1
(43) Pub. Date: Feb. 16, 2012

(54) CUTTER AND ANVIL ARRANGEMENT FOR A FIBER PLACEMENT HEAD

(75) Inventor: Milo M. Vaniglia, Cold Spring, KY (US)

(73) Assignee: CINCINNATI MACHINE, LLC, Hebron, KY (US)

(21) Appl. No.: 12/855,989

(22) Filed: Aug. 13, 2010

(51) Int. Cl. B26D 1/00

(52) U.S. Cl. 83/694

(57) ABSTRACT

A motorized head for applying fiber composite material to an application surface includes a drive roll assembly for applying fiber composite material to an application surface. The drive roll assembly includes a drive roll and a backup roll and a drive roll nip formed between the drive roll and the backup roll. At least one cutter is mounted on the drive roll for cutting fiber composite material, and an anvil is mounted on the backup roll to provide a shear surface for the cutter blade.

### FIELD OF THE DEVICE

The device relates to a head for applying fiber composite material to an application surface in which the individual lanes of fiber composite material are each driven by a drive roll and a backup roll that includes a cutter and an anvil for cutting the composite material.

### BACKGROUND

Composite lay-up machines are well known in the art. Such machines can be divided into two basic types, fiber placement machines that lay bundles of individual fibers onto a surface, and tape laying machines that apply fiber composite material in the form of a wide tape onto a surface. If the surface that receives the fiber composite material is fairly continuous, and does not have a lot of contour, a tape laying machine is normally used. If the surface is highly contoured or discontinuous because of the presence of openings in the surface, a fiber placement machine is normally used.

### SUMMARY

A fiber placement head for a fiber placement utilizes individual roller sets comprising a drive roll and backup roll for each tow lane in which each drive roll has a tow cutting and restarting mechanism carried on the roll's circumference. Each drive roll is geared to and meshes with a back-up roll that is half the diameter of the drive roll and that captures the tow material in a drive roll nip that is formed therebetween. The drive roll carries two cutters and two restarting zones, each of which are 180 degrees apart and that mesh with one anvil on the back-up roll. Each cutter has a blade edge that that is angled to provide a shearing motion across the anvil edge. Each cutter is mounted in the drive roll by a blade guide insert that can be ground to precisely control the position of the cutter on the drive roll. The anvil can be flipped over when one side wears out to renew the anvil cutting edge.

### BRIEF DESCRIPTION OF THE DRAWINGS

FIG. 1 is perspective view of the fiber delivery mechanism in a fiber placement head.

FIG. 2 is a detail of a drive roll and a portion of a backup roll showing the two opposed cutting blades.

FIG. 3 is a detail sectional view showing the drive roll in position prior to cutting the composite material.

FIG. 4 is a detail sectional view showing the drive roll as the cutter begins to cut the composite material.

FIG. 5 is a detail sectional view showing the drive roll after the cutter has cut through the composite material.

FIG. 6 is a detail sectional view of the circular area shown in FIG. 4 showing the cutter blade and the anvil.

FIG. 7 is a detail perspective view showing the cutter blade and the anvil.

FIG. 8 is a detail view taken along line 8-8 of FIG. 6 showing the cutter blade prior to cutting the fiber tow.

FIG. 9 is a perspective view of an anvil.

FIGS. 10 and 11 are front and side views, respectively, of a cutter blade.

### DESCRIPTION OF THE PREFERRED EMBODIMENT

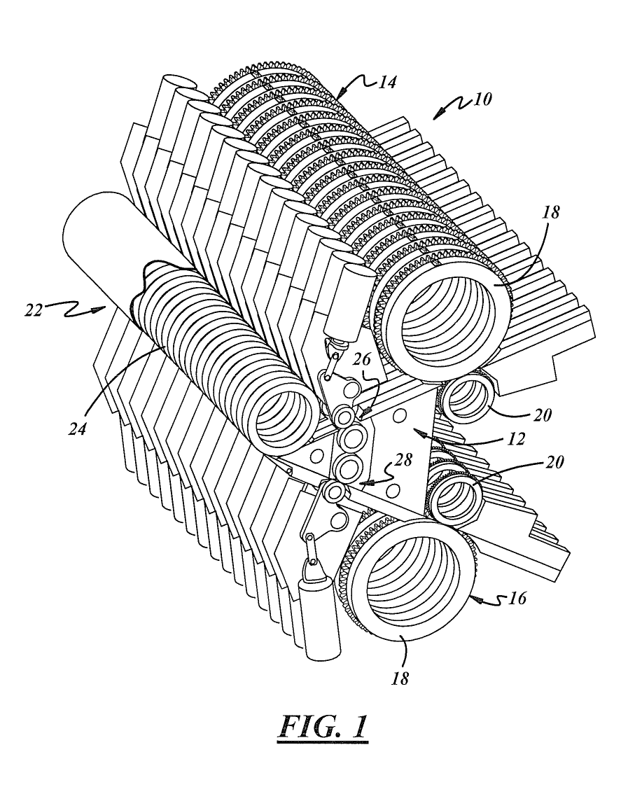

FIG. 1 is a perspective view of the fiber delivery mechanism 10 in a fiber placement head. The mechanism 10 comprises a frame structure 12 which supports an upper array of drive roll assemblies 14 and lower array of drive roll assemblies 16. Each drive roll assembly comprises a drive roll 18 and a back-up roll 20 that is half the diameter of the drive roll 18. Each drive roll assembly 14 and 16 feeds fiber composite material along a fiber composite path or lane to the compaction roll 22 located at the front of the frame as well known in the art. The fiber composite materials in the upper and lower lanes are interleaved at the compaction roll 22 to form a continuous layer of side-by-side strips on the application surface. The compaction roll 22 is formed by a series of side by side roller segments 24 so that the outer surface of the compaction roll may adapt to the contour of the surface to which the composite material is being applied. The frame 12 also supports an upper array of restart pinch roll assemblies 26 and a lower array of restart pinch roll assemblies 28 that are positioned between the drive roll assemblies 14 and 16, respectively, and the compaction roll 22. The restart pinch roll assemblies 26 and 28 drive the fiber composite material to the compaction roll 22 after the material has been cut by one of the cutters on the drive roll.

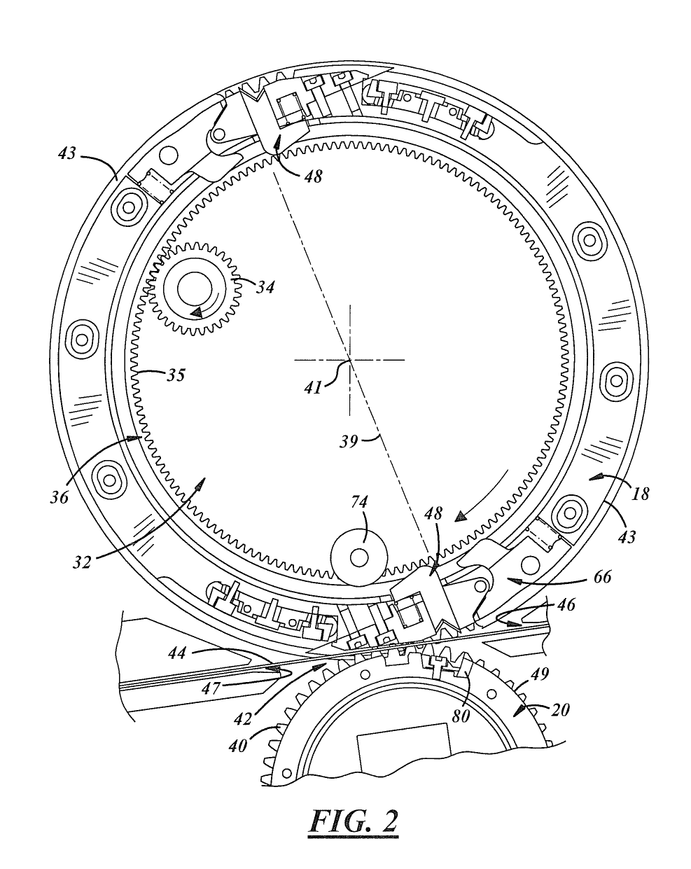

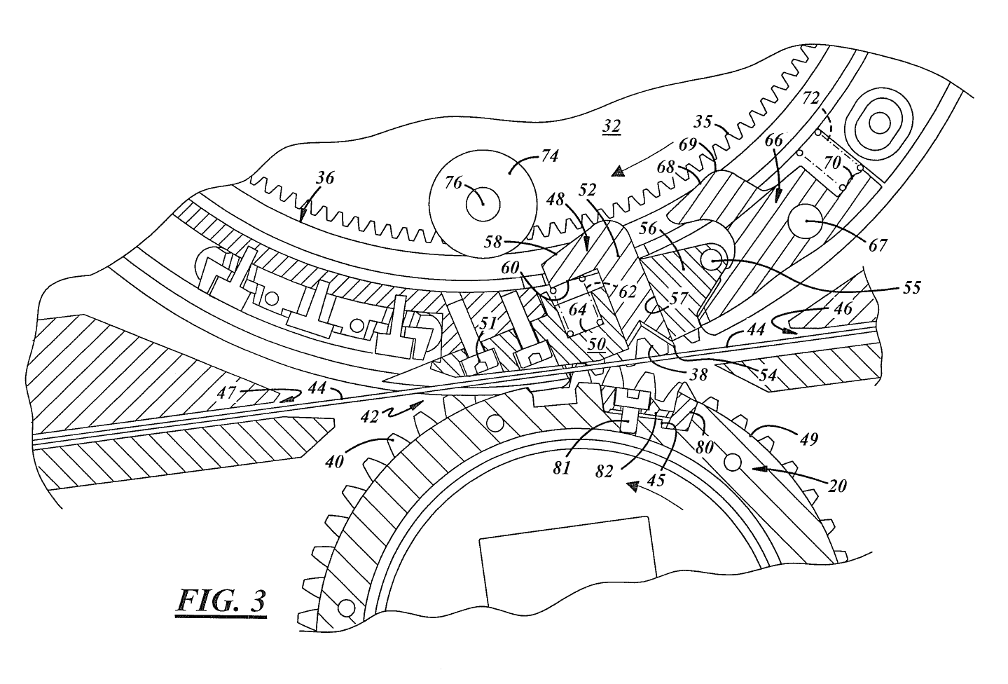

FIG. 2 is a detail view of a drive roll 18 and a portion of a backup roll 20. The drive roll 18 is mounted by bearings (not shown) on a non-rotating drive roll hub 32 that is secured to the outside frame member 12. The drive roll 18 may be driven by a drive pinion 34 that engages the internal gear teeth 35 of a ring gear 36 that is attached to the drive roll 18. Rotation of the drive roll 18 is transferred to the backup roll 20 by a drive transfer arrangement that drivingly couples the drive roll and the backup roll together. In the embodiment shown, external gear teeth 38 on the ring gear 36, best seen in FIG. 3, engage gear teeth 40 on the outside of the backup roll 20, to positively couple the rotation of the drive roll to the backup roll. The drive roll has two cutter assemblies 48 spaced one hundred and eighty degrees apart so that a diameter line 39 joining corresponding parts of the two cuter assemblies passes through the center of rotation 41 of the drive roll. A drive surface 43 is formed on the outer circumference of the drive roll following each cutter assembly 48. A tow ejector foot 66 is positioned between the cutter assembly 48 and the drive surface 43 of the drive roll. The backup roll has an anvil 80 mounted on its outer surface, and a backup drive surface 49 is formed on the outer surface of the backup roll following the anvil. A drive roll nip 42 is formed between the drive roll 18 and the backup roll 20. Fiber tow 44 is delivered to the drive roll nip 42 from an upstream fiber path chute 46, and passes through the drive roll nip 42 into a downstream fiber path chute 47.

FIG. 3 is a detail sectional view showing the drive roll in position prior to cutting the composite material. The cutter assembly 48 comprises a cutter retainer 50, a cutter blade 52, and a cutter guide insert 56 having a blade guide surface 57. The cutter retainer 50 is attached to the drive roll 18 by suitable fasteners such as screws 51 for rapid mounting and removal. The cutter blade 52 has a knife edge 54 and is mounted between the cutter retainer 50 and the blade guide surface 57 of the cutter guide insert 56. The cutter guide insert 56 mounts into the drive roll and is secured by a fastener post 55. The cutter guide insert 56 can be removed and the blade guide surface 57 can be ground to fit during assembly of the drive roll in order to precisely position the cutter blade 52 on the drive roll. The blade guide surface 57 is coincident with the diameter line 39 of the drive roll 18. A similar cutter assembly 48 is mounted on the opposite side of the drive roll 18, and the ability to precisely position the two diametrically opposed cutter blades 52 on the drive roll by means of the removable blade guide inserts 56 allows the cutter blades 52 to be precisely positioned on the diameter line 39. This precise positioning of the two cutter blades 52 allows the blades to mate with the one anvil 80 on the back up roll 20.

The cutter blade 52 has a ramp portion 58 and a spring retaining finger 60 that is formed below the ramp portion 58. A compression spring 62 is located in a spring pocket 64 formed in the cutter blade retainer 50, and the end of the spring 62 presses against the underside of the retaining finger 60. A tow ejector foot 66 is positioned behind the cutter blade retainer 50 and is mounted on a pivot shaft 67. The tow ejector foot 66 has a ramp surface 68 leading to a lobe 69, and a return spring seat surface 70. A compression spring 72 is mounted between the return spring seat surface 70 and another spring retaining surface (not shown) that is part of the drive roll assembly. A cam wheel 74 is mounted on a pivot 76 that is mounted on the non-rotating drive roll hub 32. The cam wheel 74 is in a position to impact on the ramp surface 58 of the cutter blade 52 and the ramp surface 68 of the tow ejector foot 66 as these elements rotate past the cam wheel. An anvil 80 and an anvil retainer 82 are mounted on the outer circumference of the backup roll 20. The anvil retainer 82 is held in place by one or more fastening elements such as a screw 81. FIG. 3 shows the drive roll in a position just before the cam wheel 74 impacts on the ramp surface 58 of the cutter blade 52.

FIG. 4 is a detail sectional view showing the drive roll as the cutter begins to cut the composite material. Rotation of the drive roll 18 causes the cam wheel 74 to displace the cutter blade 52 against the force of the compression spring 62, extending the knife edge 54 into the composite material 44 in the drive roll nip 42. The blade 52 is actuated by the cam wheel along a line 53 that is coincident with the diameter line 39 that passes through the center 41 of the drive roll 18.

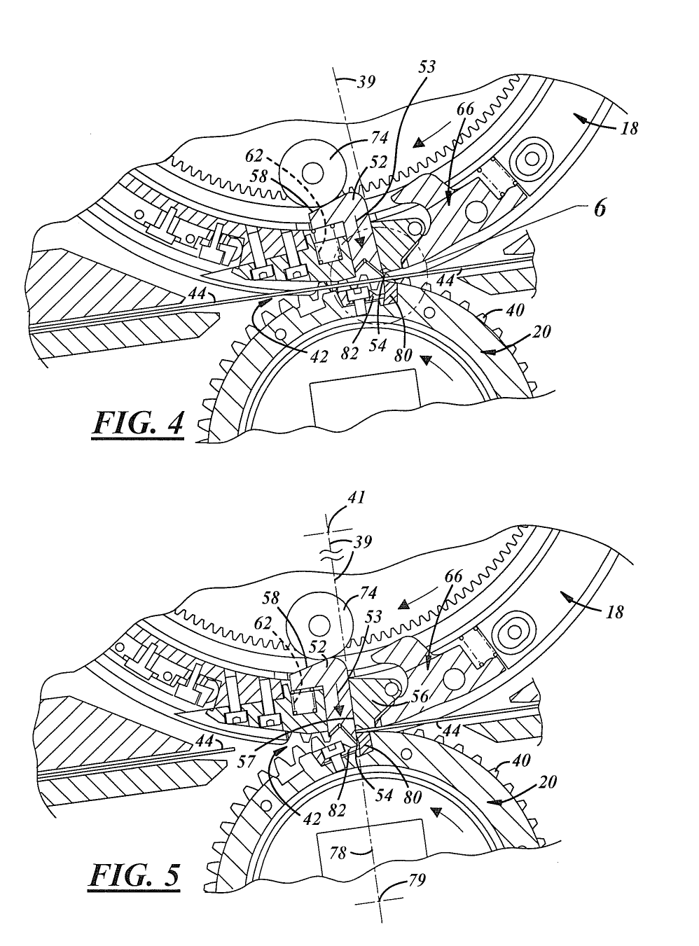

FIG. 5 is a detail sectional view showing the drive roll after the cutter has cut through the tow material 44. The knife edge 54 of the cutter blade 52 cuts through the composite material 44 and shears against the edge of the anvil 80 that is mounted on the back-up roll 20. The synchronized rotation of the drive roll 18 and the backup roll 20 ensures that the anvil 80 is always in a shearing relationship with the cutter blade 52 when the cam wheel 74 impacts the cutter. In the position shown, the blade guide surface 57 is in alignment with the diameter line 39 of the drive roll 18 and the diameter line 78 that extends from the center 79 of the backup roll 20.

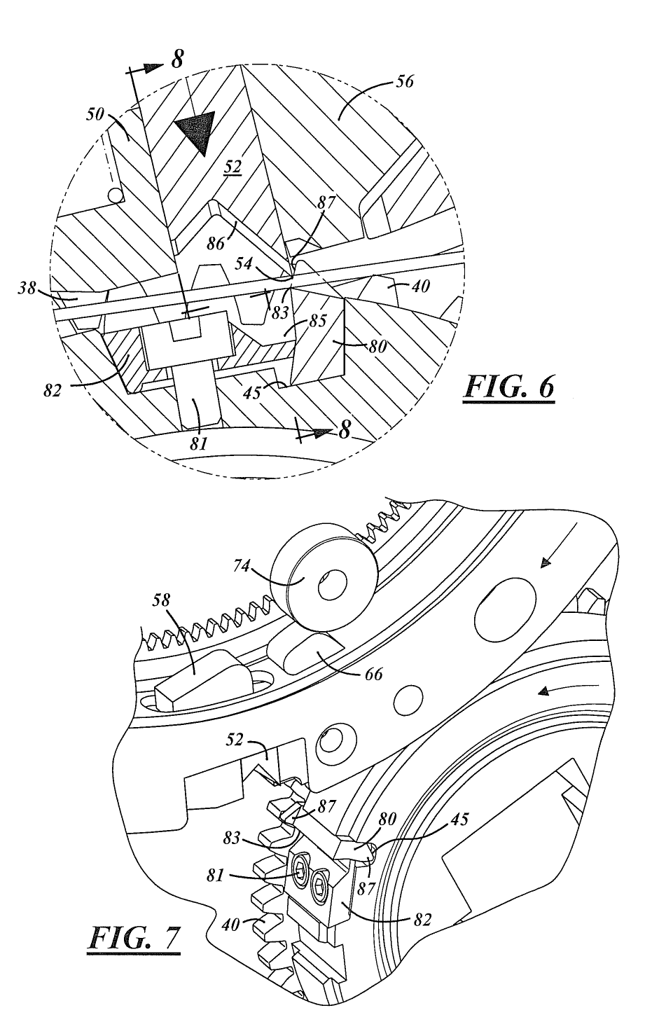

FIG. 6 is a detail sectional view of the circular area shown in FIG. 4 showing the cutter blade 52 and the anvil 80. The anvil 80 is held in an anvil pocket 45 on the backup roll 20 by the anvil retainer 82, and a recess 85 is formed between the body of the anvil 80 and the anvil retainer 82. The knife edge 54 of the cutter blade extends into the recess 85 as it shears the fiber tow against the shear edge 83 of the anvil 80. A guide foot 87 on one end of the shear edge 83 of the anvil is provided to receive and guide the tip 84 of the cutter blade 54 as the blade is driven into contact with the shear edge of the anvil. A tow pocket 86 is formed in the cutter blade 52 to allow the cutter blade to complete its cutting stroke without damaging the trailing end of the cut tow 44.

FIG. 7 is a detail perspective view showing the cutter blade 52 and the anvil 80 after the drive roll 18 and the backup roll 20 have rotated past the position in which the cutter blade 52 cuts the tow material. The anvil 80 is held by the anvil retainer 82 in the anvil pocket 45 formed in the backup roll 20.

FIG. 8 is a detail view taken along line 8-8 of FIG. 6 showing the cutter blade prior to cutting the fiber tow. The cutting edge 54 of the blade is at an angle A to the shear edge 83 of the anvil 80. The blade initially contacts the guide foot 87 on the anvil. The guide foot 87 positions the blade 52 so that it sweeps tightly across the shear edge 83. The end 91 of the blade edge 54 that first contacts the guide foot 87 may be flattened to reduce the wear of the blade on the guide foot 87.

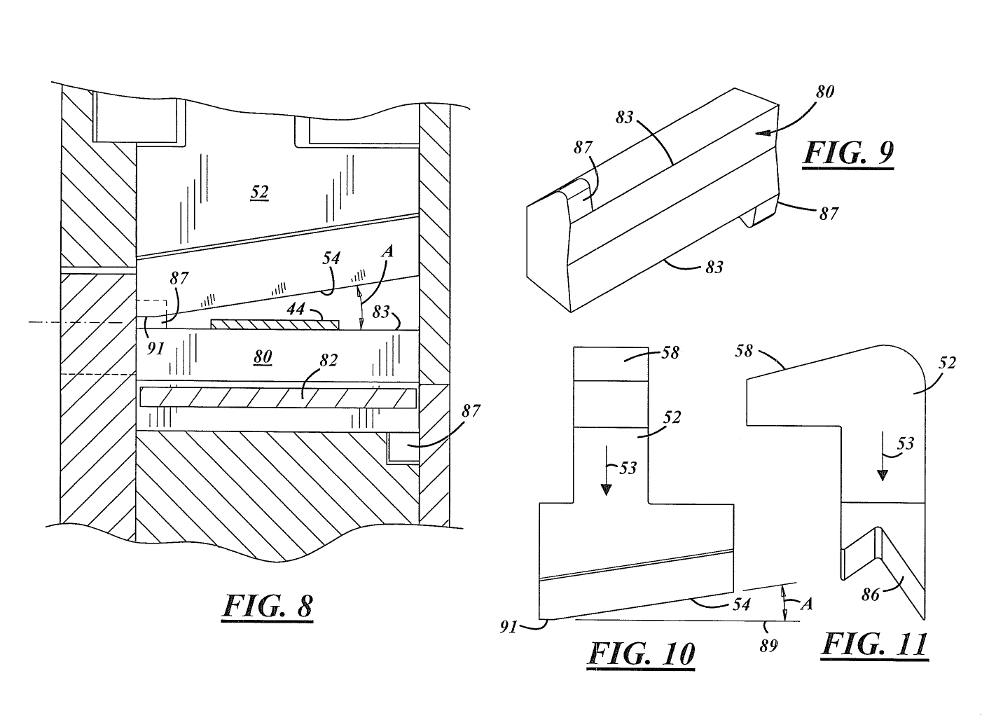

FIG. 9 is a perspective view of an anvil 80. Although the element 80 is called an anvil, it does not function as an anvil in the sense that the knife edge 54 of the cutter blade does not cut the fiber tow 44 by pressing the fiber tow against the anvil surface. A shear edge 83 is formed along the leading upper surface of the anvil 80, and the cutter blade 52 cuts the tow by sweeping along the shear edge 83. The anvil 80 has a mirrored design with two guide feet 87 and two shear edges 83. This enables the anvil to be flipped over when one of the shear edges 83 wears so that the other shear edge can be used before replacing the anvil completely.

FIGS. 10 and 11 are front and side views, respectively, of a cutter blade 52. The cutting edge 54 of the blade is at an angle A to a line 89 that is parallel to the shear edge 83 of the anvil 80. The angle A may be between 5 and 25 degrees, and an angle of between 9 and 15 degrees is preferred. It has been determined that having an angle A on the blade provides an improved shearing motion across the shear edge 83. The blade 52 features a ramp 58 that contacts the cam wheel 74. The ramp 58 provides smooth and uniform motion of the blade 52 along the line of motion 53 as it rotates past the cam wheel 74 with minimum impact load on the cam wheel 74.

Having thus described the invention, various modifications and alterations will be apparent to those skilled in the art, which modifications and alterations will be within the scope of the invention as defined by the appended claims.

1. A drive roll assembly for a fiber placement head for applying fiber composite material to an application surface, the drive roll assembly comprising:
a drive roll and a backup roll comprising the drive roll assembly;
a drive roll nip formed between the drive roll and the backup roll;
at least one cutter mechanism mounted on the drive roll for cutting fiber composite material; and,
an anvil mounted on the backup roll for shearing against the cutter mechanism.

2. The drive roll assembly of claim 1 further comprising:
a cam mounted inside the outer surface of the drive roll; and,
a displaceable cutter comprising the cutter mechanism, the cam actuating the displaceable cutter from a retracted position to sever the fiber composite material.

3. The drive roll assembly of claim 2 further comprising:
a rotatable cam wheel comprising the cam.

4. The drive roll assembly of claim 2 further comprising:
a ramp surface formed on the displaceable cutter; whereby the ramp surface provides a smooth shearing action of the cutter blade across the anvil in response to the cam wheel coming into contact with the ramp surface and depressing the cutter blade.

5. The drive roll assembly of claim 2 wherein the cam wheel displaces the cutter blade along a line that is coincident with a diameter line of the drive roll.

6. The drive roll assembly of claim 4 further comprising:
a shear edge formed on the anvil; and,
a cutting edge formed on the cutter blade, the cutting edge being at an angle to the shear edge on the anvil.

7. The drive roll assembly of claim 2 further comprising:
a return spring for the displaceable cutter, the return spring returning the cutter blade to the retracted position after the drive roll rotates the cutter blade past the cam.

8. The drive roll assembly of claim 2 further comprising:
a removable blade guide insert providing a guide surface for the cutter blade, the blade guide insert having a guide surface that is coincident with a radial line drawn through the center of rotation of the drive roll.

9. The drive roll assembly of claim 1 further comprising:
two cutter mechanisms mounted on the drive roll, the cutter mechanisms being spaced one hundred and eighty degrees apart around the circumference of the drive roll.

10. The drive roll assembly of claim 9 further comprising:
two blade guide inserts mounted on the drive roll, the two blade guide inserts being spaced one hundred and eighty degrees apart around the circumference of the drive roll, whereby the two blade guide inserts provide an adjustment mechanism for the position of the cutter blades on the drive roll so that the two opposed cutter guide surfaces are exactly in line with one another and are located on a line that passes through the drive roll center.

11. The drive roll assembly of claim 10 further comprising:
a drive transfer arrangement between the drive roll and the backup roll, whereby rotation of the drive roll is synchronized with the rotation of the backup roll, and wherein the drive roll is twice the diameter of the backup roll.

12. The drive roll assembly of claim 11 further comprising:
at least one cutter mounted on the drive roll; and,
an anvil mounted on the backup roll; whereby the drive transfer arrangement between the drive roll and the backup roll synchronizes the rotation of the drive roll and the backup roll so that the at least one cutter on the drive roll impacts the anvil on the backup roll when the cutter on the drive roll is in a shearing relationship with the anvil on the backup roll.

13. The drive roll assembly of claim 12 wherein the drive roll has an outer diameter and the backup roll has an outer diameter, and wherein the outer diameter of the drive roll is twice the outer diameter of the backup roll.

14. The drive roll assembly of claim 13 further comprising:
two cutters mounted on the drive roll, whereby the drive transfer arrangement between the drive roll and the backup roll causes each of the two cutters to impact the anvil on the backup roll at two rotational positions of the drive roll.

15. The drive roll assembly of claim 11 further comprising:
at least one cutter mounted on the drive roll; and,
an anvil mounted on the backup roll; whereby the drive transfer arrangement between the drive roll and the backup roll synchronizes the rotation of the drive roll and the backup roll so that the at least one cutter on the drive roll impacts the anvil on the backup roll when the cutter on the drive roll is in a shearing relationship with the anvil on the backup roll.

16. The drive roll assembly of claim 1 further comprising:
a guide foot structure provided on the end of the anvil, the guide foot being configured to impact the blade tip and force the cutter blade to sweep against the anvil shear edge as the cutter blade is depressed by the cam wheel.

17. The drive roll assembly of claim 16 further comprising:
a mirrored design for the cutter anvil, whereby the anvil has two shear edges and two guide feet, and whereby the anvil may be remounted on the backup roll after the first shear edge of the anvil wears out to expose the other shear edge to the cutter blade.
